(19) United States
(12) Patent Application Publication
(10) Pub. No.: US 2012/0161549 A1
(43) Pub. Date: Jun. 28, 2012

(54) SYSTEM FOR ASSEMBLING A SPEAKER MOTOR

(75) Inventor: David J. Sell, White Lake, MI (US)

(73) Assignee: Harman International Industries, Incorporated, Northridge, CA (US)

(21) Appl. No.: 12/977,988

(22) Filed: Dec. 23, 2010

(51) Int. Cl. H02K 41/035; B29C 45/14

(52) U.S. Cl. 310/12.16; 264/261; 425/577

(57) ABSTRACT

A retaining member of a speaker motor may be formed using a mold. The mold may receive a plurality of speaker motor components. The mold may be configured to receive the speaker motor components in a desired arrangement. The mold may receive an injected material. The injected material may fill unoccupied space in the mold. The injected material may be cooled to form a retaining member to retain the speaker components in the desired arrangement subsequent to removal of the speaker motor components from the mold.

### BACKGROUND OF THE INVENTION

1. Technical Field

The present disclosure relates to assembly of a speaker motor, and more specifically to assembly of a speaker motor through injection molding techniques.

2. Related Art

Loudspeakers operate through transduction of electrical signals into sound waves. A speaker motor may be used to assist in the production of sound waves. For example, a speaker motor may provide a static magnetic field to interact with a voice coil energized with alternating current. The energized voice coil may generate a magnetic field that interacts with the static magnetic field causing the voice coil to physically move, which may be used to produce the sound waves. The speaker motor may include one or more permanent magnets, as well as, other ferrous or non-ferrous metals as structural components. The components making up a speaker assembly may be fastened to one another using fasteners made of metals, both ferrous and non-ferrous. However, metals tend to expand when subjected to heat producing during loudspeaker operation. The expansion of the metals over time may degrade the performance of the corresponding loudspeaker due to the non-resilient properties of metals. Metals may also be more expensive relative to other candidate materials. Therefore, a need exists to fasten speaker motor components together with resilient material in a low-cost manner.

### SUMMARY

According to one aspect of the disclosure, a system for assembling a speaker motor may include a mold having first mold portion and a second mold portion. The mold portions may oppose one another and be selectively engageable with one another. Each of the mold portions may each receive components of a speaker motor. The mold portions may engage one another upon loading of the mold portions with the speaker motor components. The speaker motor components may each include a respective opening. Each of the speaker motor components may be disposed in the mold to align the respective openings. A molding material may be injected into the mold assembly filling unoccupied space within the mold including a passage formed of the aligned respective openings. The molding material may form a retaining member to retain the speaker motor components in a desired arrangement.

According to another aspect of the disclosure, an alignment device may be used to align the respective openings of the speaker motor components in the mold. The alignment device may be partially received by one of the mold portions when the mold portions are disengaged. Upon engagement, the other mold portion may partially receive the alignment device to align the respective openings. Upon formation of the retaining member, the alignment device may be removed from the mold.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a cross-sectional view of an example mold.

FIG. 2 is a cross-sectional view of an example speaker motor.

FIG. 3 is a cross-sectional view of a portion of the example mold of FIG. 1.

FIG. 4 is a cross-sectional view of another portion of the example mold of FIG. 1.

FIG. 5 a plan view of the example alignment device of FIG. 5

FIG. 6 is an elevation view of an example alignment device.

FIG. 7 is a cross-sectional view of the example alignment device of FIG. 5.

FIG. 8 is a cross-sectional view of the example mold of FIG. 1 having speaker motor components loaded.

FIG. 9 is a plan view of the example mold of FIG. 1 showing an example of formation of a retaining member of a speaker motor.

FIG. 10 is an operational flow diagram of an example assembly of a speaker motor.

### DETAILED DESCRIPTION OF THE PREFERRED EMBODIMENTS

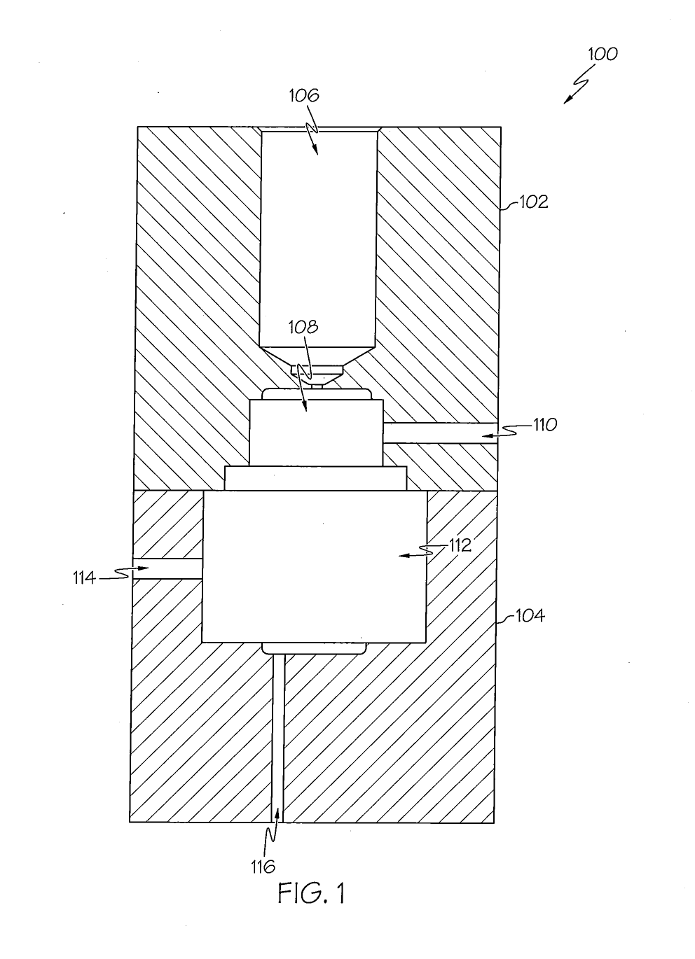

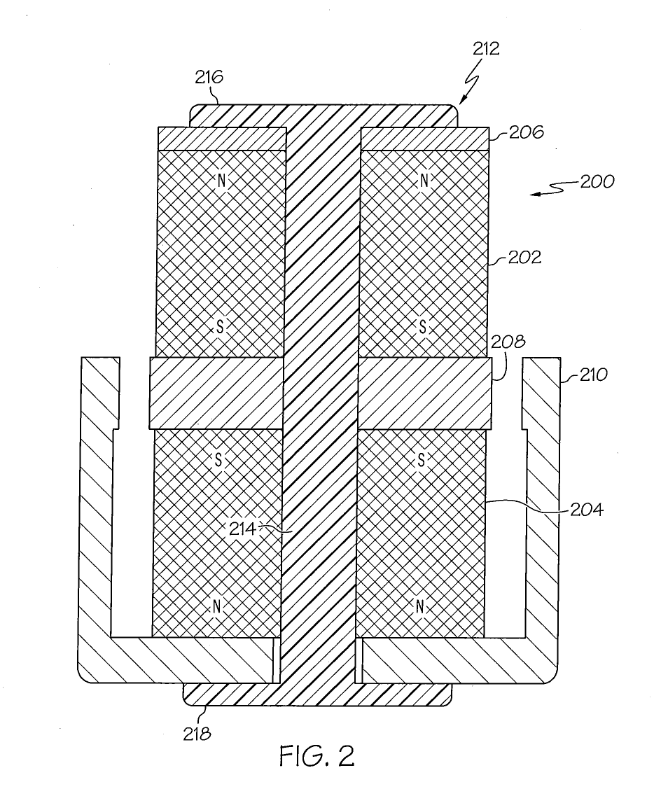

FIG. 1 is a cross-sectional view of a mold 100 that may be implemented to assemble a speaker motor (see FIG. 2). The mold 100 may include an upper mold portion 102 and a lower portion 104. The terms “upper” and “lower” may be used for ease of description and should not be construed as limiting any particular orientation, arrangement, or configuration described using the terms “upper” and “lower.” The upper mold portion 102 and the lower mold portion 104 may selectively oppose one another. FIG. 1 shows the mold 100 in a closed position with the upper mold portion 102 and the lower mold portion 104 engaging one another. The mold 100 may be opened allowing the upper mold portion 102 and the lower mold portion 104 to receive various components of a speaker motor (see FIG. 2). The mold portions 102 and 104 may be moved between open and closed positions using various types of industrial actuators (not shown) or other suitable manner for operating the mold 100.

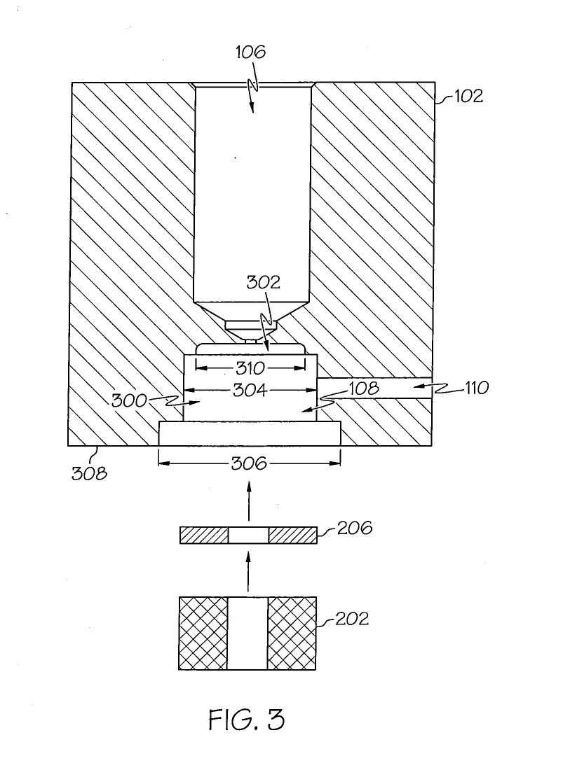

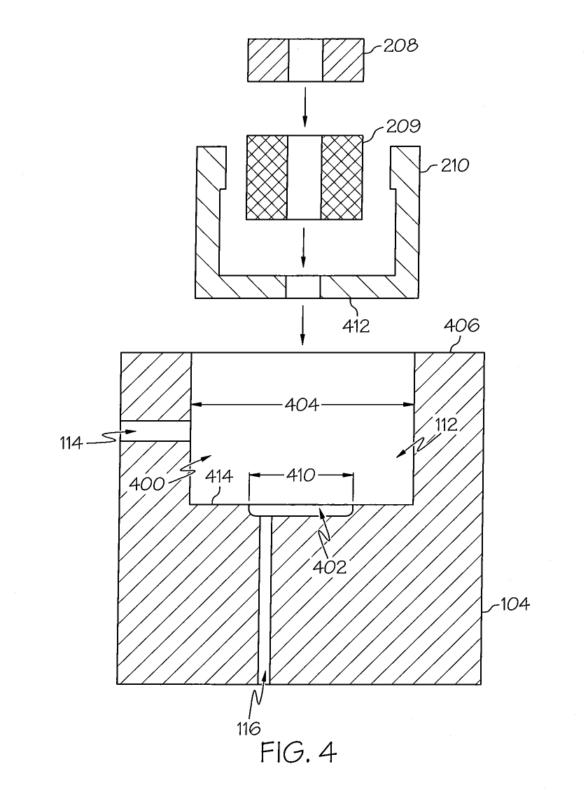

The upper mold portion 102 may include an injection nozzle cavity 106 to receive an injection molding nozzle (see FIG. 6) to deliver a molding material. The upper mold portion 102 may also include an upper motor assembly cavity 108 to receive a portion of a speaker motor (see FIG. 3). The upper mold portion 102 may also include a first pin passage 110. The lower mold portion 104 may include a lower motor assembly cavity 112 to receive another portion of a speaker motor (see FIG. 4). The bottom portion 104 may also include a second pin passage 114 and a pressure transducer passage 116.

FIG. 2 is a cross-sectional view of an example speaker motor 200 that may be assembled using the mold 100. The speaker motor 100 may include a first magnet 202 and a second magnet 204 both being permanently magnetized. A top cap 206 may be disposed adjacent the first magnet 202. A core cap 208 may be disposed between the first magnet 202 and the second magnet 204. In the example illustrated in FIG. 2, the magnets 202 and 204, and top cap 206 may be cylindrically-shaped and have substantially the same cross-sectional diameters. The core cap 208 may be cylindrically-shaped having a cross-sectional diameter greater than the magnets 202 and 204 and the top cap 206. The second magnet 204 may be disposed within a cylindrically-shaped shellpot 210. In alternative examples, the magnets 202 and 204, caps 206 and 208, and shellpot 210 may have respective shapes other than cylindrical. In one example, the top cap 206, core cap 208, and shellpot 210 may each be formed of ferrous materials having low-reluctance properties.

The magnets 202 and 204, caps 206 and 208, and shellpot 210 may each include a centrally-aligned opening. The openings may be circular and concentrically positioned with the cross-section of the respective component. In alternative examples, the openings may be eccentrically disposed with respect to the corresponding component and may also be non-circular in shape. As further explained herein, the openings may be aligned when disposed in the mold 100. An injection-molded material may be injected through the aligned openings to form a retaining member 212. The retaining member 212 may include a post 214 contiguously formed with a pair of end members 216 and 218. The end members 216 and 218 may be wider than the openings of the top cap 208 and shellpot 210, respectively, to retain the magnets 202 and 204, caps 206 and 208, and shellpot 210 along the post 214. In FIG. 2, the end members 216 and 218 are substantially identical and have a disk-shape. In alternative examples, the end members 216 and 218 may have other shapes and may be shaped differently from one another.

FIG. 3 is a cross sectional view of the upper mold portion 102 of the mold 100 prior to receiving components of the speaker motor 200. The first motor assembly cavity 108 may include a motor assembly cavity portion 300 and an end member cavity portion 302. The first motor assembly cavity portion 300 may be complimentary-shaped to receive the first magnet 202 and the top cap 206. For example, in FIG. 3, the first motor assembly cavity 300 may be cylindrically-shaped to receive the first magnet 202 and top cap 206 illustrated in FIG. 2.

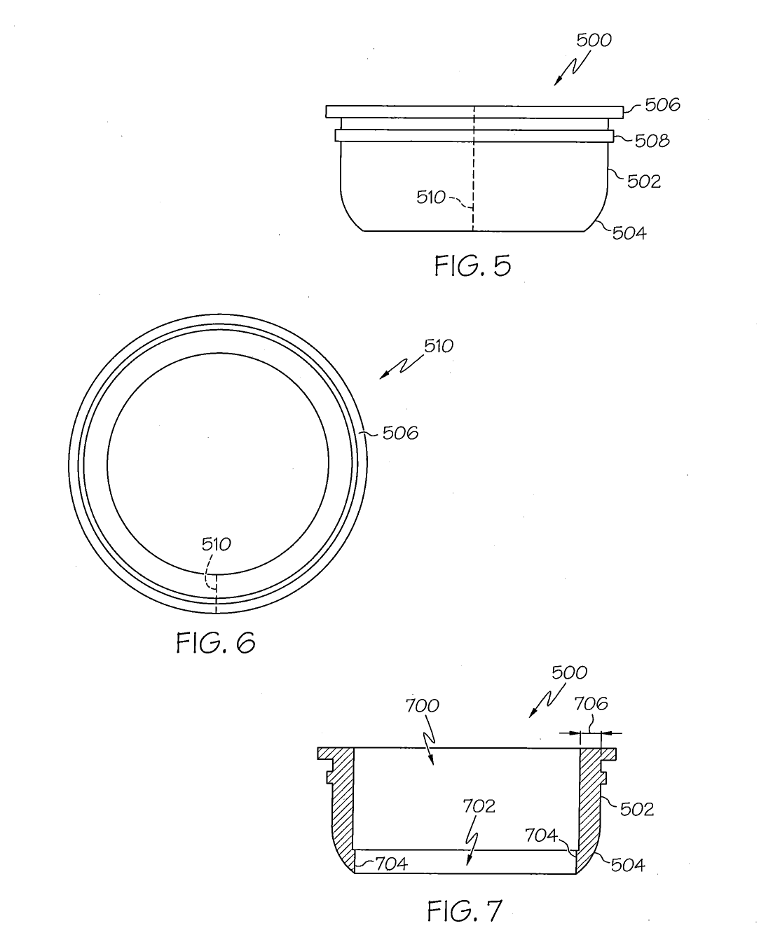

The first motor assembly cavity 300 may include a first diameter 304 and a second diameter 306. The first diameter 304 may be dimensioned to snuggly receive the first magnet 202 and the top cap 206. The second diameter 306 may be greater than the first diameter 304 to accommodate the diameter of the first magnet 202 and a portion of an alignment collar (see FIG. 5). The first motor assembly cavity portion 300 may receive the top cap 206 followed by the first magnet 202 when being loaded into the mold 100 for assembly of the speaker motor 200. The depth of the first motor assembly cavity portion 300 may be substantially equal to the combined thicknesses of the top cap 206 and the first magnet 202 allowing a lower surface of the first magnet 202 to be substantially flush with a bottom surface 308 of the first portion 102.

The end member cavity portion 302 may have a diameter 310 less than the diameter 304. The difference in the diameters 304 and 310 may provide a stop for the top cap 206 as it is loaded into the first motor assembly cavity portion 300. The end member cavity portion 302 provides space for the molding material to occupy, allowing formation o f the end member 216 as further described with regard to FIG. 6.

FIG. 4 is cross-sectional view of the lower mold portion 104 of the mold 100. The second motor assembly cavity 112 may include a second motor assembly cavity portion 400 and an end member cavity portion 402. The second motor assembly cavity portion 400 may be complimentary-shaped to receive the shellpot 210. In one example, the second motor assembly cavity portion 400 may have a diameter 404 to snuggly receive the circular cross-section shape of the shellpot 210. The shellpot 210 may be loaded into the second motor assembly cavity portion 400 followed by the second magnet 204 and, subsequently, the core cap 208. The depth of the second motor assembly cavity portion 400 may be substantially equal to the height of the shellpot 210 such that an upper edge of the shellpot 210 is substantially flush with a top surface 406 of the lower mold portion 104. The second magnet 204 and core cap 208 may have a combined thickness to allow an upper edge of the core cap 208 to be flush with top surface 406 of the lower mold portion 104 when the second magnet 202 is placed on the shellpot 210 and the core cap 208 is placed on the second magnet 202 as illustrated in FIG. 5.

The end member cavity portion 402 may have a diameter 410 less than the diameter 404. The difference in the diameters 404 and 410 may provide a stop for the shellpot 210 as it is loaded into the first motor assembly cavity portion 300. The end member cavity portion 402 may also provide space for the injection-molded material occupy when injected allowing formation of the end member 212 as further described with regard to FIG. 6.

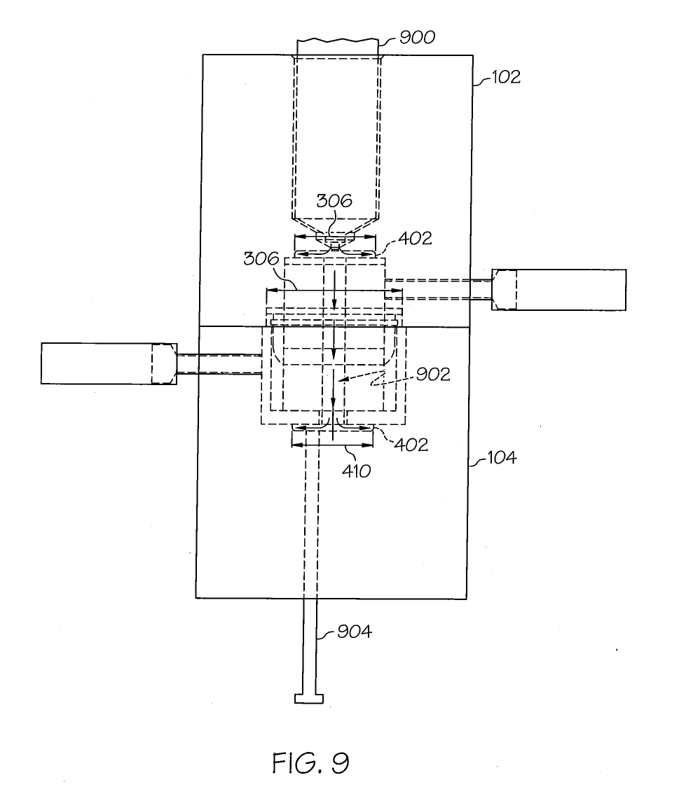

Once the shellpot 210, second magnet 204, and core cap 208 are loaded into the lower mold portion 104, the respective openings may be aligned to receive the molding material in order to form the retaining member 212. An alignment collar 500 may be used to perform such alignment. FIGS. 5 and 6 are a plan view and elevation view, respectively, of one example of the alignment collar 500 that may be used to align components of the speaker motor assembly 200 in the mold 100. The alignment collar 500 may include a body 502. In one example, the body 502 may be substantially cylindrical and a have tapered end 504. The alignment collar 500 may also include an upper circumferential ridge 506 and a lower circumferential ridge 508 both extending outwardly from the body 502. The alignment collar 500 may include a seam 510 formed longitudinally along the body 502 and ridges 506 and 508. In one example, the seam 510 may be a thinner, weaker, and/or perforated portion of the material forming the alignment collar 500. The alignment collar 500 may be disconnected or torn at the seam 510 through manually pulling the alignment collar 500 or through use of a tool (not shown). Disconnection at the seam 510 may allow the alignment collar 500 to be pulled around and away from the speaker motor 200 upon formation as further described with regard to FIG. 8. In an alternative example, the alignment collar 500 may have a preexisting disconnected portion.

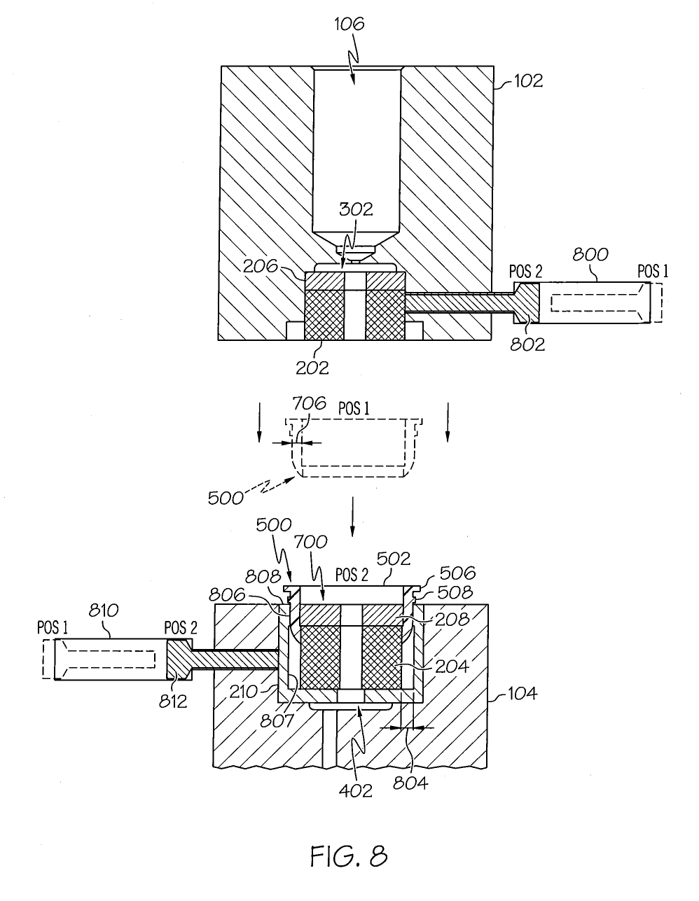

FIG. 7 is a cross-sectional view of the alignment collar 500. The body 502 may form a first cylindrical cavity 700. A second cylindrical cavity 702 may be formed by a ridge 704 extending inwardly from the body 502. The ridge 704 may be used to facilitate alignment in as further described with regard to FIG. 8. The body 502 may have a thickness 706 extending to the tapered end 504. The alignment collar 500 may be formed of various resilient materials such as plastics or metal, for example. The alignment collar 500 may be formed of various resilient materials such as plastics or metal, for example. In alternative examples the alignment collar 500 may have various configurations. For example, the body 502 may include less material such that the body 502 has extensions forming the tapered end 504 instead of the tapered end 504 being continuous. In another example, the alignment collar 500 may be formed of spring steel or may be made from metal with spring steel fingers that contribute to alignment. The alignment collar 500 may also be made from a combination of plastic with spring steel fingers.

FIG. 8 is a cross-sectional view of the mold 100 in an open position and having components of the speaker motor 200 loaded prior to the injection of the molding material. As previously described, the top cap 206 may be loaded into the first motor assembly cavity portion 300 followed by the first magnet 202. Upon loading into the first motor assembly cavity portion 300, an upper pin guide 800 may be inserted into the first pin passage 110. An upper fixing pin 802 may guided through the upper pin guide 800 from an initial position, designated as “POS 1” to a second position designated as “POS 2.” In the second position, the upper fixing pin 802 may engage the first magnet 202 to fix the first magnet 202 and the top cap 206 into the position shown in FIG. 5. The upper fixing pin 802 may be actuated through an automated device (not shown) or other suitable manner.

The lower mold portion 104 may receive the shellpot 210, second magnet 204, and the core cap 208. As illustrated in FIG. 5, alignment of the openings in each of the shellpot 210, second magnet 204, and core cap 208 may cause an air gap 804 to be formed between the shellpot 210 and both the first magnet 204 and the core cap 208. The shellpot 210 may have a circumferential ridge 806 extending inwardly from an interior surface 807 of the shellpot 210. The air gap 804 may be narrower between the ridge 806 and the core cap 208 than between the shellpot 210 and second magnet 204.

The alignment collar 500 may be partially inserted into the second motor assembly cavity portion 400 such that the lower ridge 508 comes into contact with a top edge 808 of the shellpot 210. The thickness 706 of the body 502 may substantially occupy the entire space between the core cap 208 and the ridge 806 closing off the air gap 804. Occupying the entire space between the ridge 806 and the core cap 208 may substantially fix the core cap 208 and the second magnet 204 into the aligned position illustrated in FIG. 8. FIG. 8 shows the alignment collar 500 in phantom located in a first position designated as “POS 1” above the lower mold portion 104. A second position of the alignment collar 504 designated as “POS 2” is shown in which the alignment collar 500 has been placed into the second motor assembly cavity portion 400. As the alignment collar 500 is moved into POS 2, the ridge 702 may be forced between the ridge 806 and the core cap 208. The alignment collar 500 may be formed of a compressible and resilient material allowing the ridge 704 to engage the second magnet 204 allowing the alignment collar 500 to be substantially fixed into the POS 2 position shown in FIG. 8.

A lower pin guide 810 may be inserted through the lower pin passage 114 and a lower fixing pin 812 may be guided through the lower pin guide 810 from a first position “POS 1” to a second position “POS 2” in which the lower fixing pin 812 engages the shellpot 210 to fix the shellpot 210 within the second motor assembly cavity portion 400. The lower fixing pin 812 may be actuated through an automated device (not shown) or other suitable manner.

FIG. 9 is a view of the mold 100 in a closed position with internal components shown in phantom. As the upper mold portion 102 and the lower mold portion 104 are brought into proximity with one another, the top ridge 506 of the alignment collar 500 may be received by the second diameter 306 of the first motor assembly cavity portion 300 between the first magnet 202 and an edge of the upper mold portion 102 at the edge of the first motor assembly cavity portion 300 forming the diameter 306. The top ridge 506 may have a width substantially equal to the width of the unoccupied space to assist in alignment of the components of the speaker motor 200 in the upper mold portion 102 with those in the lower mold portion 104.

Once the mold portions 102 and 104 are brought together, an injection-molding nozzle 900 may inject a molding material into the end member cavity portion 302. Alignment of components of the speaker motor 200 may form a passage 902 that is contiguous with the end member cavity portions 302 and 402. The injected material may flow through the passage of to fill the end member cavity portion 402. Enough material may be injected to fill the passage 902, as well as, the end member cavity portion 302. A pressure transducer 904 may be positioned in transducer passage 116. The pressure transducer 904 may measure the pressure being applied within the mold 100 by the injected material. A particular pressure may indicate that the proper amount of molding material has been injected. The injected material may be cooled to form the retaining member 212.

The retaining member 212 may be formed of a thermoplastic, such as a polymer, that is reduced to liquid form upon being heating above a melting point temperature and becomes solid after being cooled at a temperature lower than the melting point for sufficient amount of time. In one example, the retaining member 212 may be formed for of a thermoplastic such as Ultramid Polymide 66 produced by BASF Corp. of Ludwigshafen, Germany. Amorphous and crystalline thermoplastics may be used to form the retaining members. Thermoplastics may be used that enter a fluid state at a temperature s substantially lower than that of the materials forming the mold 100, other components of the speaker motor 200, and the alignment collar 500. Such a temperature may also be substantially lower than temperatures that may permanently demagnetize the magnets 202 and 204. The retaining member 212 may be formed of thermoplastics allowing the use of low-pressure injection molding techniques. In one example, the thermoplastics may be a moldable polyamide adhesive. Low-pressure injection molding techniques allow less complicated configurations to be used and are less expense than conventional molding techniques.

A cooling phase may be introduced to cool the molding material allowing formation of the retaining member 212. Various cooling techniques may be implemented, such as injecting coolant through coolant pores (not shown) disposed in the mold 100. Other suitable manners of cooling the molding material may be implemented. Upon expiration of the cooling phase, the mold 100 may be opened. In one example, the upper mold portion 102 may be disengaged from the lower mold portion 104 such that speaker motor 200 remains disposed in the lower mold 104. The fixing pin 802 may be disengaged from the magnet 202 prior to disengagement of the mold portions 102 and 104. In one example, upon withdrawal of the upper mold portion 102, the alignment collar 510 may be removed from the bottom mold 104. The lower mold portion 104 may use various manners of ejection, such as ejector pins (not show) to eject the speaker motor 200. The fixing pin 828 may be disengaged from the shellpot 210 prior to the ejection.

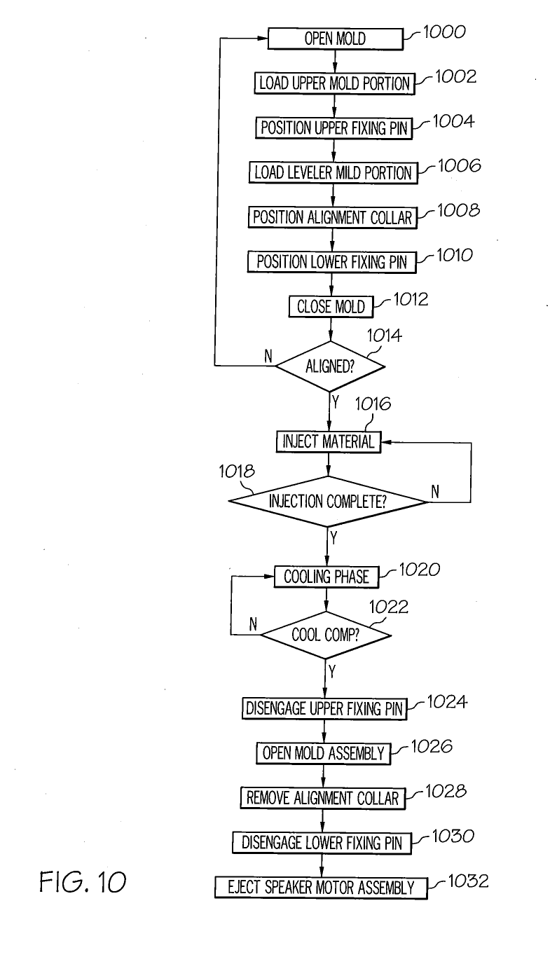

FIG. 10 is an operational flow diagram of assembling the speaker motor 200 with the mold 100. The mold 100 may be opened to receive components of the speaker motor 200 (block 1000). The upper mold portion 102 may be loaded with components of the speaker motor 200 (block 1002) such as the top cap 206 and the first magnet 204. The upper fixing pin 802 may be actuated to engage the first magnet 202 to fix the top cap 206 and the first magnet 202 within the upper mold portion 102 (block 1004). The lower mold portion 104 may be loaded with components of the speaker motor 200 (block 1006) such as the shellpot 210, second magnet 204, and the core cap 208. The alignment collar 510 may be positioned in the lower mold portion 104 (block 1008) to align the openings in the shellpot 210, second magnet 204, and the core cap 208. The lower fixing pin 812 may be actuated to engage the shellpot 210 (block 1010) to fix the shellpot 210 within the second mold cavity portion 400.

The mold 100 may be closed (block 1012) to bring the surface 308 of the upper mold portion 102 into contact with the surface 406 of the lower mold portion 104, which may also allow the upper mold portion 102 to receive the top ridge 506 of the alignment collar 500 as discussed with regard to FIGS. 5 and 6. Once closed, a determination regarding the desired alignment may be made (block 1014). Alignment may be determined through various manners such as visual inspection or electronic sensors, such as pressure sensors for example. If desired alignment is not present, the mold may be opened, and reloading may take place in any desired order or manner.

If the desired alignment is present, the molding material may be injected through the injection nozzle 900 (block 1016). During the period of injection, a determination may be made regarding completion of the injection of molding material (block 1018). In one example, the completion may be based on reading from the pressure transducer 904. If injection is not complete, the injection may continue. If the injection is complete, a cooling phase may be entered (block 1020). Cooling may be in various manners, such as cooling the ambient environment, cooling fluids, or any other suitable manner. A determination of sufficient cooling may be performed (block 1022). If cooling is not complete, the cooling phase may be maintained.

Once cooling has completed, the upper fixing pin may be disengaged from the first magnet 202 (block 1024). The mold 100 may be opened (block 1026) and the alignment collar 510 may be removed from the lower mold portion 104 and from around the speaker motor assembly 200 (block 1028). The lower fixing pin 812 may be disengaged from the shellpot 210 (block 1030). The speaker motor 200 may be ejected from the lower mold portion 104 (block 1032).

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A method of assembling a speaker motor, the method comprising:
inserting a first speaker motor portion into a first mold portion of a mold;
inserting a second speaker motor portion into a second mold portion of the mold; and
injecting a heated material into the first mold portion and the second mold portion to form a retaining member configured to fasten the first speaker motor portion and the second speaker motor portion to one another.

2. The method of claim 1, further comprising engaging the second mold portion with the first mold portion prior to injecting the heated material.

3. The method of claim 2 further comprising:
inserting at least a first portion of an alignment device into one of the first mold portion and the second mold portion; and
receiving at least a second portion of the alignment device with the other one of the first mold and the second mold during engagement of the second mold portion with the first mold portion, wherein receipt of the alignment device aligns at least one opening in the first speaker motor portion with at least one opening in the second speaker motor portion.

4. The method of claim 2, further comprising:
cooling the retaining member;
disengaging the first mold portion from the second mold portion, where the alignment device remains in one of the first mold portion and the second mold portion; and
removing the alignment device from the one of the first mold portion and second mold portion in which the alignment device remains.

5. The method of claim 1, wherein inserting the first speaker motor portion into the first mold portion comprises inserting at least one of a top cap and a magnet into the first mold portion.

6. The method of claim 5 further comprising positioning a fixing pin to fix the magnet within the first mold portion.

7. The method of claim 6, further comprising releasing the fixing pin from the magnet subsequent to formation of the retaining member.

8. The method of claim 1, wherein inserting the second speaker motor portion into the second mold portion comprises inserting at least one of a shellpot, a magnet, and a core cap into the second mold portion.

9. The method of claim 8, further comprising positioning a fixing pin to fix the shellpot within the second mold portion.

10. The method of claim 9, further comprising releasing the fixing pin from the shellpot subsequent to formation of the retaining member.

11. A mold configured to form a speaker motor, the mold comprising:
a first cavity configured to receive a first speaker motor portion and a first portion of a retaining member formed of an injected material; and
a second cavity configured to receive a second speaker motor portion and a second portion of the retaining member.

12. The mold of claim 11, wherein each of the first cavity and second cavity is configured to receive a respective portion of an alignment collar configured to align at least one respective opening in each of the first speaker motor portion and the second speaker motor portion.

13. The mold of claim 11, comprising:
a first portion, where the first portion includes the first cavity; and
a second portion, where the second portion includes the second cavity, and where the second portion is selectively engageable with the first portion.

14. The mold of claim 13, where the first portion includes a passage configured to receive a fixing pin to fix the first speaker motor portion in the first cavity.

15. The mold of claim 11, where the first cavity is configured to receive at least one of a top cap and a magnet.

16. The mold of claim 11, where the first cavity is configured to receive at least one of a shellpot, magnet, and a core cap.

17. The mold of claim 11, where the first cavity and the second cavity are each configured to shape a respective end portion of the retaining member, where each respective portion of the retaining member is shaped to retain the first speaker motor portion and the second speaker motor portion between the respective end members.

18. A speaker motor produced by the method of:
loading a first portion of the speaker motor into a first mold portion of a mold;
loading a second portion of the speaker motor into a second mold portion of the mold; and
forming a retaining member within the mold to fasten the first portion of speaker motor to the second portion of the speaker motor.

19. The speaker motor of claim 18, where loading the first portion of the speaker motor comprises loading the first portion of the speaker motor into a first cavity formed in the first mold portion, and where loading the second portion of the speaker motor comprises loading the second portion of the speaker motor into a second cavity formed in the second mold portion.

20. The speaker motor of claim 19, where forming the retaining member within the mold comprises receiving an injected material heated into a fluid state into the first cavity and the second cavity.

21. The speaker motor of claim 20, where forming the retaining member further comprises:
receiving the heated material into a portion of the second cavity;
filling a passage with the heated liquid, where the passage is contiguously formed between the portion of the second cavity and a portion of the first cavity; and
receiving the heated material into the portion of the first cavity.

22. The speaker motor of claim 21, where forming the retaining member further comprises aligning the first cavity with the second cavity to create the passage within the first speaker motor portion and the second speaker motor portion.

23. The speaker motor of claim 22, where forming the retaining member further comprises cooling the heated material to a temperature sufficient to form the retaining member.

24. The speaker motor of claim 18 produced by the method further comprising:
fixing the first speaker motor portion in the first mold portion prior to forming the retaining member; and
fixing the second speaker motor portion in the second mold portion prior to forming the retaining member.

25. A method of forming a retaining member of a speaker motor:
positioning a plurality of speaker motor components in a mold, where the speaker components are positioned in a predetermined arrangement;
injecting a material into unoccupied space within the mold;
cooling the material to form a retaining member configured to retain the plurality of speaker motor components in the predetermined arrangement upon removal from the mold.
